(19) United States
(12) Patent Application Publication
(10) Pub. No.: US 2013/0076758 A1
(43) Pub. Date: Mar. 28, 2013

(54) Page Switching Method And Device

(71) Applicant: Tencent Technology (Shenzhen) Company Limited, Shenzhen (CN)

(72) Inventors: Xungeng LI, Shenzhen (CN); Linzhou ZHENG, Shenzhen (CN); Qian JIANG, Shenzhen (CN); Dan LIU, Shenzhen (CN); Heng DUANMU, Shenzhen (CN); Yu CHEN, Shenzhen (CN); Yanmin YANG, Shenzhen (CN); Mao WANG, Shenzhen (CN); Zongqing WANG, Shenzhen (CN); Xiaowen YAO, Shenzhen (CN); Qing WANG, Shenzhen (CN)

(73) Assignee: TENCENT TECHNOLOGY (SHENZHEN) COMPANY LIMITED, Shenzhen (CN)

(21) Appl. No.: 13/677,902

(22) Filed: Nov. 15, 2012

Related U.S. Application Data
(63) Continuation of application No. PCT/CN2011/077103, filed on Jul. 13, 2011.

(30) Foreign Application Priority Data
Sep. 2, 2010 (CN) 201010273252.3

(51) Int. Cl. G06T 13/00

(52) U.S. Cl. CPC G06T 13/00
USPC 345/473

(57) ABSTRACT

A page switching method and device. The method includes: displaying current message page; when detecting a touch operation, drawing a page-turning animation according to the touch operation, and playing the page-turning animation; and when the touch operation stops, displaying an adjacent message page.

### CROSS-REFERENCE TO RELATED APPLICATIONS

This application is a continuation of International Application No. PCT/CN2011/077103 filed on Jul. 13, 2011. This application claims the benefit and priority of Chinese Application No. 201010273252.3, filed Sep. 2, 2010. The entire disclosures of each of the above applications are incorporated herein by reference.

### FIELD

The present disclosure relates to network technologies, and to a method and device for switching between pages.

### BACKGROUND

This section provides background information related to the present disclosure which is not necessarily prior art.

In addition to the growing popularity of mobile phone networks, microblog has been widely used by users. The microblog is a product, which is initially designed according to phone usage habits. The microblog is an abbreviation of micro blog, which is an internet application product based on user relationship. A user may log on, share, transmit and obtain information with various internet terminals.

After analyzing existing technologies, at least the following problems have been found by the inventor. A smooth transition cannot be implemented, when a user browses messages and turns pages, that is, switches between a previous message page and a next message page.

### SUMMARY

This section provides a general summary of the disclosure, and is not a comprehensive disclosure of its full scope or all of its features.

Various embodiments provide a method and device for switching between pages, so as to implement a smooth transition when switching between a previous message page and a next message page.

A page switching method, including:

displaying current message page;

when detecting a touch operation, drawing a page-turning animation according to the touch operation, and playing the page-turning animation; and

when the touch operation stops, displaying an adjacent message page.

A page switching device, including:

a first displaying module, which is to display current message page;

an operation receiving module, which is to receive a touch operation;

an animation drawing module, which is to draw a page-turning animation according to the touch operation;

a playing module, which is to play the page-turning animation; and

a second displaying module, which is to display an adjacent message page, when the touch operation stops.

In view of above, it can be seen that, by adopting the technical solutions, draw and play a page-turning animation to imitate a book page-turning effect according to a touch operation of a user, so as to implement the smooth transition when switching between a previous message page and a next message page.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

The exemplary embodiments are described in detail in the following accompanying with attached figures, to enable one having ordinary skill in the art to understand features and advantages of the disclosure.

FIG. 1 is a flowchart illustrating a page switching method in accordance with an embodiment.

FIG. 2 is a flowchart illustrating a page switching method in accordance with a preferred embodiment.

FIG. 3 is a schematic diagram illustrating drawing mode of an in-page-turning animation, in accordance with an embodiment.

FIG. 4 is a schematic diagram illustrating structure of a page switching device, in accordance with an embodiment.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

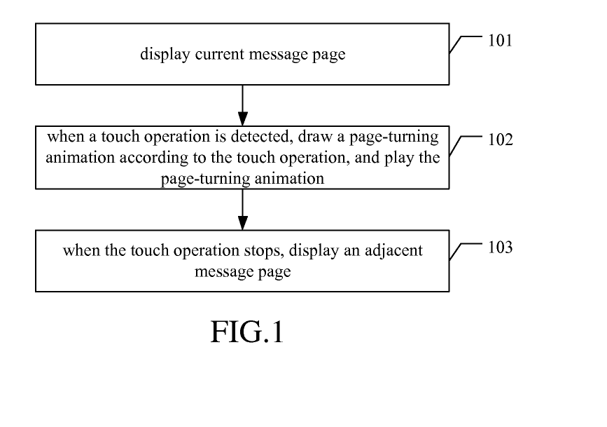

FIG. 1 is a flowchart illustrating a page switching method in accordance with an embodiment. As shown in FIG. 1, the method includes the following blocks.

Block 101, display current message page.

Block 102, when detecting a touch operation, draw a page-turning animation according to the touch operation, and play the page-turning animation.

Block 103, when the touch operation stops, display an adjacent message page.

An adjacent message page may refer to a previous adjacent message page, or a next adjacent message page.

Thus, it can be seen that a draw and play a page-turning animation imitates a book page-turning effect according to the touch operation of a user, so as to implement the smooth transition when switching between a previous message page and a next message page.

Different page-turning animations may be drawn, according to different sliding speeds of user's touch operations. Specifically, when the sliding speed is larger than a preset threshold, draw a fast page-turning animation to imitate a fast book page-turning. Otherwise, draw an in-page-turning animation to imitate a slow book page-turning.

When no user operation is detected within a preset duration from displaying current message page, automatically display a next adjacent message page, so as to accelerate message promotion.

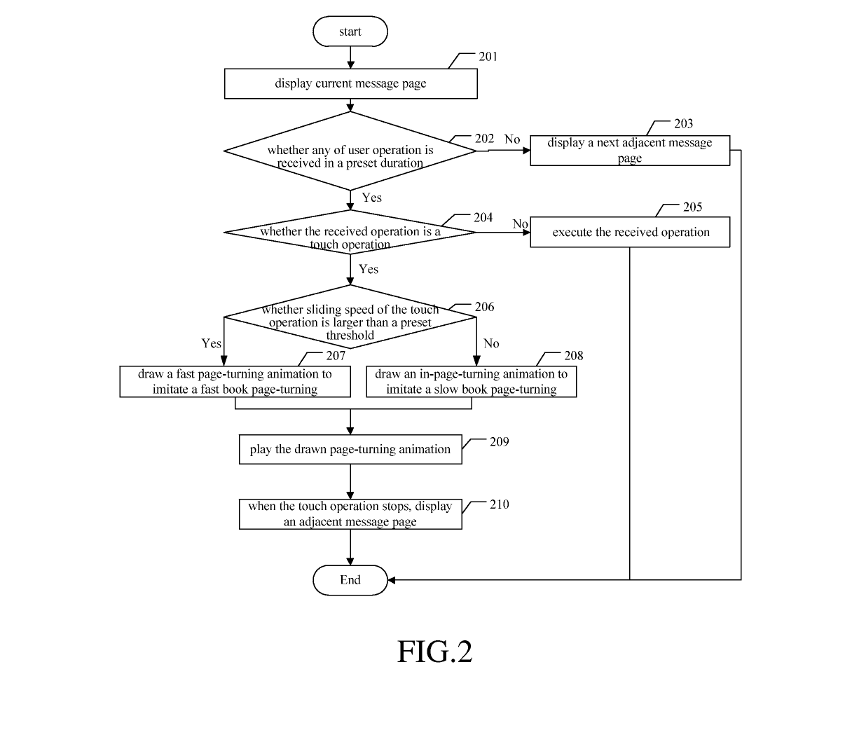

FIG. 2 is a flowchart illustrating a page switching method, in accordance with a preferred embodiment. As shown in FIG. 2, the method includes the following blocks.

Block 201, display current message page.

Block 202, determine whether any of user operation is received within a preset duration. If yes, proceed with block 204. Otherwise, proceed with block 203.

The preset duration may be set by a system in advance, or may be set by a user according to the user's reading habits.

Block 203, display a next adjacent message page, and terminate the process.

When no user operation is received within the preset duration, in which the user operation includes page-turning, downwards, etc, the user may be considered as finishing reading current message page according to default settings, automatically display a next adjacent message page, so as to achieve the objective of automatically displaying message contents for a user.

It should be noted that, the page refers to a view which displays a message. View size may be set according to maximum capacity of a message. In a microblog system, the maximum capacity of a message is 140 words. Subsequently, minimum view size should enable to view 140 words on a page.

Block 204, determine whether the received operation is a touch operation. If yes, proceed with block 206. Otherwise, proceed with block 205.

The touch operation may refer to an operation of touching a screen by a user's fingertip, or an operation executed by a touchpen, which is not limited here.

Block 205, execute the received operation, and terminate the process.

One having ordinary skill in the art may recognize that there may be various operations, e.g., close current message page, enlarge some areas of current page, or other operations performed on a page or an application program, etc.

Block 206, determine whether sliding speed of the touch operation is larger than a preset threshold. If yes, proceed with block 207. Otherwise, proceed with block 208.

The determining objective is to differentiate whether the touch operation belongs to fast sliding or slow sliding. When the sliding speed is larger than the preset threshold, the touch operation may belong to the fast sliding. When the sliding speed is smaller than or equal to the preset threshold, the touch operation may belong to the slow sliding. Different processing modes may be employed, accompanied by different determining results.

Block 207, draw a fast page-turning animation to imitate a fast book page-turning, and then proceed with block 209.

There may be two sliding directions of the touch operation, that is, sliding towards the right and sliding towards the left. Sliding towards the right corresponds to reading forward, such as reading a previous adjacent message page. Sliding towards the left corresponds to reading backward, such as reading a next adjacent message page.

The specific implementation of the block may be as follows.

207a, obtain a horizontal motion trace of touch point from one side of view area to the other side of the view area, according to touch point location and sliding direction of the touch operation.

207b, draw an in-page-turning animation from a starting point of the motion trace to an ending point of the motion trace.

It should be noted that, when determining the touch operation is a fast sliding, play the page-turning animation drawn previously according to the sliding direction. For the sliding towards the right, play the page-turning animation to turn pages forward. For the sliding towards the left, play the page-turning animation to turn pages backward, so as to accelerate processing speed and save usage resources.

Block 208, draw an in-page-turning animation to imitate a slow book page-turning, and then proceed with block 209.

Draw the page-turning animation to display designated part of current message page and designated part of an adjacent message page, according to the touch point location of the touch operation, and so on.

The specific implementations of the block may be as follows.

208a, compute a first area to display the designated part of current message page, a second area to display the designated part of an adjacent message page, and a third area to display the reverse side of the page, according to the touch point location of the touch operation and paper folding characteristics

It should be noted that, the view of the page-turning animation may employ two layer structures, which may be respectively referred to as a first layer structure and a second layer structure, according to a sequence from top to bottom. The first layer structure includes contents of current message page. The second layer structure includes contents of an adjacent message page. Before triggering the animation, the first layer may cover the second layer, and what is displayed in current view is contents of current message page.

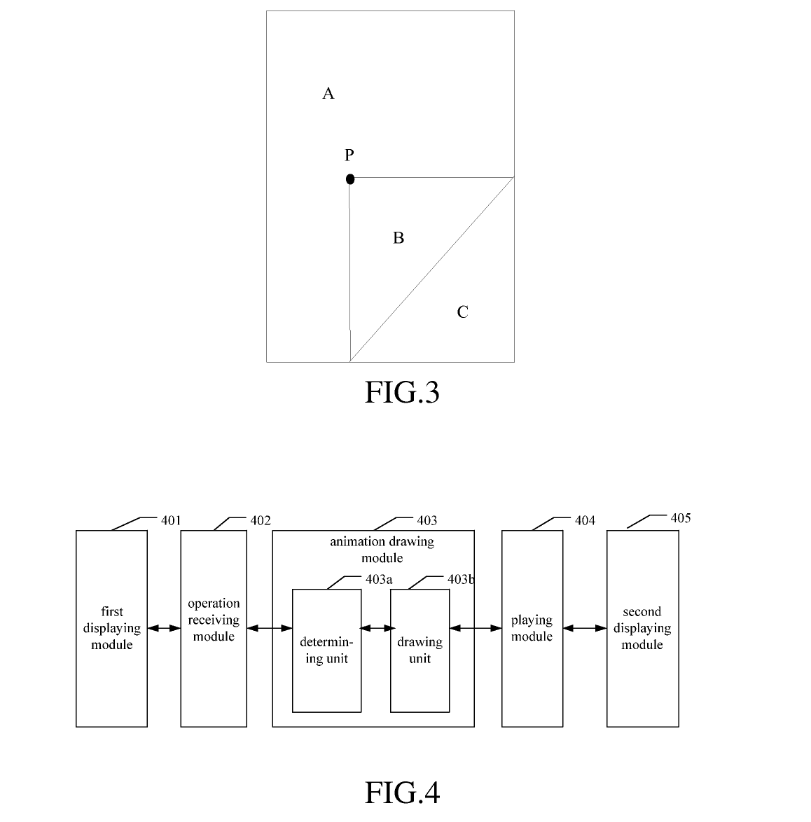

FIG. 3 is a schematic diagram illustrating drawing mode of a page-turning animation, in accordance with an embodiment. As shown in FIG. 3, when touch point location is point P, a first area A, a second area C and a third area B may be obtained after computing.

208b, draw a page-turning animation, which includes the first area, the second area and the third area.

In the first layer structure of the view, the first area A may maintain to display contents of current message page. The second area C may be drawn as a transparent color, so as to remove the contents of current message page originally displayed in the second area C. Contents of an adjacent message page located in an area of the second layer structure corresponding to the second area C may be displayed in the second area C of the first layer structure. The third area B may be drawn as a preset color, to denote the reverse side of the page.

Furthermore, perform smooth processes on connection points between the third area B and the first area A, to imitate paper curling effect, so as to enable a more realistic animation effect.

The above processes for drawing the page-turning animation are as follows. Draw the page-turning animation, by respectively displaying the designated part of current message page and designated part of an adjacent message page with the first layer structure and the second layer structure of the view, according to the touch point and sliding direction of the touch operation. Furthermore, above blocks 207 and 208 are processes to select to display page-turning animations with different effects, according to determination about sliding speed of the touch operation.

Block 209, play the drawn page-turning animation.

It should be noted that, when playing an in-page-turning animation to imitate the slow book page-turning, because of movement of touch point location, it is necessary for each area scope to simultaneously draw a page-turning animation accompanying with touch point change, and to play the page-turning animation, so as to imitate the in-page-turning effects. Thus, the smooth transition may be implemented, when switching between a previous message page and a next message page.

Block 210, when the touch operation stops, display an adjacent message page, and terminate the process.

The page switching method in the embodiment may be applied to the ANDROID mobile phone operation system developed by the GOOGLE company, and may also be applied to other Symbian systems with manual touch-screen. The page switching method provided by various embodiments may also be applied to a microblog system for pushing scenes, e.g., popular broadcast, to users. Thus, when pushing a popular broadcast to a user, it may determine whether it is necessary to automatically perform page-turning, based on whether a user operation has been received within a preset duration, so as to enable the user to read the popular broadcast automatically or manually.

FIG. 4 is a schematic diagram illustrating structure of a page switching device, in accordance with an embodiment. As shown in FIG. 4, the device includes:

a first displaying module 401, which is to display current message page;

an operation receiving module 402, which is to receive a touch operation;

an animation drawing module 403, which is to draw a page-turning animation to imitate a book page-turning according to the touch operation;

a playing module 404, which is to play the page-turning animation; and

a second displaying module 405, which is to display an adjacent message page, when the touch operation stops.

The animation drawing module 403 may include:

a determining unit 403a, which is to determine whether sliding speed of the touch operation is larger than a preset threshold; and

a drawing unit 403b, which is to draw a fast page-turning animation to imitate a fast book page-turning, when the determining unit 403a determines that the sliding speed of the touch operation is larger than the preset threshold. The drawing unit 403b is to draw an in-page-turning animation to imitate a slow book page-turning, when the determining unit 403a determines that the sliding speed of the touch operation is smaller than or equal to the preset threshold.

The drawing unit 403b may include (to simplify attached figures, the following sub units are not shown in the attached figures):

a first drawing sub-unit, which is to draw the fast page-turning animation. That is, to obtain a horizontal motion trace about a touch point from one side of view area to the other side of the view area, according to touch point location and sliding direction of the touch operation; and to draw the in-page-turning animation from a starting point of the motion trace to an ending point of the motion trace; and

a second drawing sub-unit, which is to draw the in-page-turning animation; that is, compute a first area to display designated part of current message page, a second area to display designated part of an adjacent message page and a third area to display the reverse side of the page, according to touch point location of the touch operation and paper folding characteristics, and draw the in-page-turning animation including the first area, the second area and the third area.

The view includes two layer structures, which may be respectively referred to as a first layer structure and a second layer structure, according to the sequence from top to bottom. The second drawing sub-unit is located within the first layer structure. The second drawing sub-unit may enable the first area to maintain to display contents of current message page, draw the second area as a transparent color, so as to remove the contents of current message page previously displayed in the second area, display in the second area of the first layer structure contents of an adjacent message page corresponding to a second area in the second layer structure, and draw the third area as a preset color, so as to denote the reverse side of the page.

The second drawing sub-unit is further to perform smooth processes on connection points between the third area and the first area, so as to imitate paper curling effects.

The second displaying module 405 is further to display a next adjacent message page, when no operation has been received within a preset duration, starting from the first displaying module 401 displays current message page.

Idea about the device provided by various embodiments is the same as that of the method embodiment. The specific implementation process of the device may refer to the method embodiment, which is not repeated here.

All or part of the above technical solutions provided by various embodiments may be completed by related hardware instructed by a program. The program may be stored in a readable storage media. Subsequently, the storage media may include various media which may store program codes, such as Read-Only Memory (ROM), Random Access Memory (RAM), disk or Compact Disk (CD)-ROM.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A page switching method, comprising:
displaying current message page;
when detecting a touch operation, drawing a page-turning animation according to the touch operation, and playing the page-turning animation; and
when the touch operation stops, displaying an adjacent message page.

2. The method according to claim 1, wherein drawing the page-turning animation according to the touch operation comprises:
determining whether sliding speed of the touch operation is larger than a preset threshold;
when the sliding speed of the touch operation is larger than the preset threshold, drawing a fast page-turning animation to imitate a fast book page-turning; and
when the sliding speed of the touch operation is equal to or smaller than the preset threshold, drawing an in-page-turning animation to imitate a slow book page-turning.

3. The method according to claim 2, wherein drawing the fast page-turning animation to imitate the fast book page-turning comprises:
obtaining a horizontal motion trace of a touch point from one side of a view area to the other side of the view area, according to touch point location and sliding direction of the touch operation; and
drawing the in-page-turning animation from a starting point of the motion trace to an ending point of the motion trace.

4. The method according to claim 2, wherein drawing the in-page-turning animation to imitate the slow book page-turning comprises:
computing a first area to display designated part of current message page, a second area to display designated part of an adjacent message page and a third area to display a page reverse side, according to touch point location of the touch operation and paper folding characteristics; and
drawing the page-turning animation which comprises the first area, the second area and the third area.

5. The method according to claim 4, wherein drawing the page-turning animation which comprises the first area, the second area and the third area comprises:
dividing a view into two layer structures, which are respectively referred to as a first layer structure and a second layer structure, according to a sequence from top to bottom;
maintaining to display contents of current message page in the first area of the first layer structure;
drawing the second area in the first layer structure as a transport color, so as to remove the contents of current message page previously displayed in the second area;
displaying in the second area of the first layer structure contents of an adjacent message page corresponding to a second area in the second layer structure; and
drawing the third area in the first layer structure as a preset color, so as to denote the page reverse side.

6. The method according to claim 5, further comprising:
performing a smooth process on connection points of the third area and the first area, to imitate paper curling effects.

7. The method according to claim 1, further comprising:
displaying a next adjacent message page, when no operation has been received within a preset duration, starting from displaying current message page.

8. A page switching device, comprising:
a first displaying module, which is to display current message page;
an operation receiving module, which is to receive a touch operation;
an animation drawing module, which is to draw a page-turning animation according to the touch operation;
a playing module, which is to play the page-turning animation; and
a second displaying module, which is to display an adjacent message page, when the touch operation stops.

9. The device according to claim 8, wherein the animation drawing module comprises:
a determining unit, which is to determine whether sliding speed of the touch operation is larger than a preset threshold; and
a drawing unit, which is to draw a fast page-turning animation to imitate a fast book page-turning, when the determining unit determines that the sliding speed of the touch operation is larger than the preset threshold; the drawing unit is further to draw an in-page-turning animation to imitate a slow book page-turning, when the determining unit determines that the sliding speed of the touch operation is equal to or smaller than the preset threshold.

10. The device according to claim 9, wherein the drawing unit comprises a first drawing sub-unit and a second drawing sub-unit,
the first drawing sub-unit is to draw the fast page-turning animation, which comprises: obtaining a horizontal motion trace of a touch point from one side of a view area to the other side of the view area, according to touch point location and sliding direction of the touch operation, and drawing the in-page-turning animation from a starting point of the motion trace to an ending point of the motion trace; and
the second drawing sub-unit is to draw the in-page-turning animation, which comprises: computing a first area to display designated part of current message page, a second area to display designated part of an adjacent message page and a third area to display a page reverse side, according to the touch point location of the touch operation and paper folding characteristics, and drawing the page-turning animation which comprises the first area, the second area and the third area.

11. The device according to claim 10, wherein a view comprises two layer structures, which are respectively referred to as a first layer structure and a second layer structure based on a sequence from top to bottom,
the second drawing sub-unit, which is located in the first layer structure, is to enable the first area to maintain to display contents of current message page, draw the second area as a transparent color, so as to remove the contents of current message page previously displayed in the second area, enable the second area in the first layer structure to display contents of an adjacent message page corresponding to a second area in the second layer structure, draw the third area as a preset color, so as to denote the page reverse side.

12. The device according to claim 10, wherein the second drawing sub-unit is further to perform a smooth process on connection points of the third area and the first area, to imitate paper curling effects.

13. The device according to claim 8, wherein the second displaying module is further to display a next adjacent message page, when no operation has been detected within a preset duration, starting from displaying current message page by the first displaying module.
